(19) United States
(12) Patent Application Publication
(10) Pub. No.: US 2024/0422019 A1
(43) Pub. Date: Dec. 19, 2024

(54) METHOD, SYSTEM, AND COMPUTER READABLE STORAGE MEDIA FOR JOURNALIZING AN E-NOTARY

(71) Applicant: Deposition Solutions, LLC d/b/a Lexitas, Houston, TX (US)

(72) Inventors: Mark HOORWITZ, Hewlett, NY (US); Frank IMBURGIO, Spring, TX (US)

(21) Appl. No.: 18/743,982

(22) Filed: Jun. 14, 2024

Related U.S. Application Data
(60) Provisional application No. 63/508,286, filed on Jun. 15, 2023.

(51) Int. Cl. H04L 12/18; G10L 21/043; G10L 21/055; G10L 25/57; H04N 5/76

(52) U.S. Cl. CPC H04L 12/1822; G10L 21/043; G10L 21/055; G10L 25/57; H04N 5/76

(57) ABSTRACT

A method, apparatus, and computer-readable medium for journalizing an e-notary in a computing device is provided. An identity of a witness can be verified remotely via the computing device such that a notary can notarize a legal proceeding involving the witness conducted over a video conference. The computing device can record audio and video of the video conference. The identity of the witness and the recording can be journalized and maintained in the computing device.

### RELATED APPLICATION DATA

This application claims priority to U.S. Provisional Application No. 63/508,286, filed Jun. 15, 2023, the disclosure of which is hereby incorporated by reference in its entirety.

### FIELD

This disclosure relates generally to technological advances relating to audio and video capture and storage across networks useful in legal proceedings, particularly depositions in which witnesses are sworn in.

### BACKGROUND

Recent technological advancements have changed how individuals conduct both social and professional activities. User devices, such as smartphones and personal computers, support video conferencing applications that can be used to interact with others in various situations. For example, users can video conference to speak with family members in different geographic locations. Users can also video conference to readily gather together a group who otherwise would need to expend time and resources to assemble at a particular location. Organizations have hosted significant videoconferencing usage to maintain productivity away from the workplace. Users have continued to adopt these technologies as world events have caused people to remain in their homes and refrain from working on-site.

Legal proceedings are not immutable to this development. Professionals, clients, and support services in the legal industry have adapted to participating in remote, or virtual, proceedings conducted over video conference. In this way, legal proceedings could continue while world events restricted people to their homes. Even as on-site activities have resumed, users can prefer video conferences to conduct social and professional activities, including legal proceedings and aspects thereof, to avoid unnecessary travel and related coordination.

Some aspects of legal proceedings require verification traditionally performed in person. For example, a notary, or a legally authorized witness to such verification, can participate in legal proceedings by verifying signatures on documents. The notary can serve to authenticate the execution of the signature by confirming the identity of the signer. While in the physical vicinity of the signer, the notary can verify the identification and signature process. Verification remains a requirement even as aspects of legal proceedings remain virtual. In addition, notaries in some jurisdictions may be obligated to comply with particular verification processes. For example, the notary can be obligated to record verification activities in a journal. Therefore, a need exists to facilitate verification and related obligations while the notary and signer are remote.

### BRIEF DESCRIPTION OF THE DRAWINGS

Example embodiments in accordance with this disclosure will now be described with reference to the attached figures.

FIG. 1 depicts exemplary embodiments of an e-notary journalizing system in accordance with this disclosure;

FIG. 2 depicts an exemplary embodiment of a method for journalizing an e-notary in accordance with this disclosure;

FIG. 3 depicts an exemplary embodiment of a method for journalizing an e-notary in accordance with this disclosure;

FIG. 4 presents an exemplary embodiment of an e-notary user interface in accordance with this disclosure;

FIG. 5 presents an exemplary embodiment of a notarial record journal user interface consistent with this disclosure;

FIG. 6 presents an exemplary embodiment of witness list and add witness user interface in accordance with this disclosure;

FIG. 7 presents an exemplary embodiment of an add witness information user interface consistent with this disclosure;

FIG. 8 presents an exemplary embodiment of an add witness information confirmation user interface consistent with this disclosure;

FIG. 9 presents an exemplary embodiment of the witness list and add witness user interface of FIG. 6;

FIG. 10 presents an exemplary embodiment of a witness verification user interface in accordance with this disclosure;

FIG. 11 presents an exemplary embodiment of a capture witness identification user interface consistent with this disclosure;

FIG. 12 presents an exemplary embodiment of the capture witness identification user interface of FIG. 11;

FIG. 13 presents an exemplary embodiment of the capture witness identification user interface of FIG. 11;

FIG. 14 presents an exemplary embodiment of the witness verification user interface of FIG. 10;

FIG. 15 presents an exemplary embodiment of the witness verification user interface of FIG. 10;

FIG. 16 presents an exemplary embodiment of the witness verification user interface of FIG. 10;

FIG. 17 presents an exemplary embodiment of the witness verification user interface of FIG. 10;

FIG. 18 presents an exemplary embodiment of the witness verification user interface of FIG. 10;

FIG. 19 presents an exemplary embodiment of the witness verification user interface of FIG. 10;

FIG. 20 presents an exemplary embodiment of the witness verification user interface of FIG. 10;

FIG. 21 presents an exemplary embodiment of the witness verification user interface of FIG. 10;

FIG. 22 presents an exemplary embodiment of a recording save confirmation user interface consistent with this disclosure;

FIG. 23 presents an exemplary embodiment of the witness list and add witness user interface of FIG. 6;

FIG. 24 presents an exemplary embodiment of the notarial record journal user interface of FIG. 5;

FIG. 25 presents an exemplary embodiment of an attorney user interface consistent with this disclosure;

FIG. 26 presents an exemplary embodiment of an easy pass user interface consistent with this disclosure;

FIG. 27 presents an exemplary embodiment of the easy pass user interface of FIG. 26;

FIG. 28 presents an exemplary embodiment of the easy pass user interface of FIG. 26;

FIG. 29 presents an exemplary embodiment of the easy pass user interface of FIG. 26;

FIG. 30 presents an exemplary embodiment of a backend user interface consistent with this disclosure;

FIG. 31 presents an exemplary embodiment of a backend user interface consistent with this disclosure; and

FIG. 32 illustrates the components of the specialized computing environment configured to perform the specialized method for journalizing an e-notary consistent with this disclosure.

### SUMMARY

Embodiments provide a method for journalizing, by a computing device, an e-notary. The method can include verifying, by the computing device, the identity of a witness. The method can also include merging, by the computing device, a first audio track of the witness and a second audio track of a notary to form a system audio track. The method can also include recording, by the computing device, the system audio track and a video of a video conference for a swearing in of the witness. The swearing in can be conducted by the notary over the video conference. The method can also include generating, by the computing device, an e-notary journal data file for the e-notary. The e-notary journal data file can be based at least in part on the identity of the witness and the recording of the system audio track and the video.

In some embodiments, the verifying, by the computing device, the identity of the witness can include inputting, by the computing device, a primary contact information of the witness. The verifying, by the computing device, can also include sending, by the computing device, a prompt to the primary contact information of the witness to upload, or otherwise transmit, a photograph of an identification of the witness. The verifying, by the computing device, can also include receiving, by the computing device, the photograph of the identification of the witness. The verifying, by the computing device, can also include storing, by the computing device, the identification of the witness in an encrypted format.

In some embodiments, the verifying, by the computing device, the identity of the witness can include inputting, by the computing device, a primary contact information of an attorney of the witness. The verifying, by the computing device, can also include sending, by the computing device, a prompt to the primary contact information of the attorney to provide an affirmation from the attorney of the identity of the witness. The verifying, by the computing device, can also include receiving, by the computing device, the affirmation from the attorney of the identity of the witness. In some embodiments, verifying, by the computing device, the identity of the witness can include sending, by the computing device, a prompt to the primary contact information of the attorney to upload, or otherwise transmit, a photograph of an identification of the attorney. The verifying, by the computing device, can also include receiving, by the computing device, the photograph of the identification of the attorney. The verifying, by the computing device, can also include storing, by the computing device, the identification of the attorney in an encrypted format.

In some embodiments, the merging, by the computing device, the first audio track of the witness and the second audio track of the notary to form the system audio track can include matching, by the computing device, an audio tempo of each of the first audio track and the second audio track such that the first audio track and the second audio track are in sync.

In some embodiments, the recording, by the computing device, the system audio track and the video of the video conference for the swearing in of the witness can include prompting, by the computing device, the notary to record via a web browser. In some embodiments, the recording, by the computing device, the system audio track and the video of the video conference for the swearing in of the witness can also include prompting, by the computing device, the notary to select a screen comprising the video conference. In some embodiments, the recording, by the computing device, the system audio track and the video of the video conference for the swearing in of the witness can also include recording, by the computing device, the screen comprising the video conference. In some embodiments, the recording, by the computing device, the system audio track and the video of the video conference for the swearing in of the witness can also include prompting, by the computing device, the notary to stop recording via the web browser.

In some embodiments, the recording of the system audio track and the video of the video conference for the swearing in of the witness is conducted on a user device of the notary.

In some embodiments, the generating, by the computing device, the e-notary journal data file for the e-notary can include associating, by the computing device, an encryption key with the e-notary journal data file. The generating, by the computing device, the e-notary journal data file for the e-notary can also include storing, by the computing device, the e-notary journal data file in an encrypted format.

In some embodiments, the generating, by the computing device, the e-notary journal data file for the e-notary can also include storing, by the computing device, time and date data associated with the e-notary journal data file. The generating, by the computing device, the e-notary journal data file for the e-notary can also include providing, by the computing device, a token to the notary to access the encrypted format to retrieve the e-notary journal data file.

In some embodiments, the method for journalizing, by the computing device, the e-notary can also include receiving, by the computing device, information about the witness. The information about the witness can include at least one of a first name, a last name, and a witness type. The e-notary journal data file can include the information about the witness.

Embodiments also provide a method for journalizing, by a computing device, an e-notary. The method can include verifying, by the computing device, the identity of a witness. The method can also include conducting, by the computing device, a video conference between the witness and a notary. The method can also include recording, by the computing device, a screen comprising the video conference for a swearing in of the witness. The swearing in can be conducted by the notary over the video conference. The method can also include generating, by the computing device, an e-notary journal data file for the e-notary. The e-notary journal data file can be based at least in part on the identity of the witness and the recording of the screen comprising the video conference.

Embodiments also provide a system for journalizing an e-notary. The system can include a computing device configured to verify the identity of a witness; merge a first audio track of the witness and a second audio track of a notary to form a system audio track; record the system audio track and a video of a video conference for a swearing in of the witness, the swearing in conducted by the notary over the video conference; and generate an e-notary journal data file for the e-notary, the e-notary journal data file based at least in part on the identity of the witness and the recording of the system audio track and the video.

In some embodiments, the computing device configured to verify the identity of a witness is further configured to input a primary contact information of the witness; send a prompt to the primary contact information of the witness to upload, or otherwise transmit, a photograph of an identification of the witness; receive the photograph of the identification of the witness; and store the identification of the witness in an encrypted format.

In some embodiments, the computing device configured to verify the identity of a witness is further configured to input a primary contact information of an attorney of the witness; send a prompt to the primary contact information of the attorney to provide an affirmation from the attorney of the identity of the witness; and receive the affirmation from the attorney of the identity of the witness. In some embodiments, the computing device is further configured to send a prompt to the primary contact information of the attorney to upload, or otherwise transmit, a photograph of an identification of the attorney; receive the photograph of the identification of the attorney; and store the identification of the attorney in an encrypted format.

In some embodiments, the computing device configured to merge the first audio track of the witness and the second audio track of the notary to form the system audio track is further configured to match an audio tempo of each of the first audio track and the second audio track such that the first audio track and the second audio track are in sync.

In some embodiments, the computing device configured to record the system audio track and the video of the video conference for the swearing in of the witness is further configured to prompt the notary to record via a web browser; prompt the notary to select a screen comprising the video conference; record the screen comprising the video conference; and prompt the notary to stop recording via the web browser

In some embodiments, the computing device is on a user device of the notary.

In some embodiments, the computing device configured to generate the e-notary journal data file for the e-notary is further configured to associate an encryption key with the c-notary journal data file; and store the e-notary journal data file in an encrypted format. In some embodiments, the computing device is further configured to store time and date data associated with the e-notary journal data file; and provide a token to the notary to access the encrypted format to retrieve the e-notary journal data file.

In some embodiments, the computing device is further configured to receive information about the witness. The information about the witness can include at least one of a first name, a last name, and a witness type. The e-notary journal data file can include the information about the witness.

Embodiments also provide a system for journalizing an e-notary. The system can include a computing device configured to verify the identity of a witness; conduct a video conference between the witness and a notary; record a screen comprising the video conference for a swearing in of the witness, the swearing in conducted by the notary over the video conference; and generate an e-notary journal data file for the e-notary, the e-notary journal data file based at least in part on the identity of the witness and the recording of the screen comprising the video conference.

Embodiments also provide a non-transitory computer-readable storage medium having computer-executable instructions stored thereon for journalizing an e-notary. Executing the computer-executable instructions on a computing device causes the computing device to verify the identity of a witness; merge a first audio track of the witness and a second audio track of a notary to form a system audio track; record the system audio track and a video of a video conference for a swearing in of the witness, the swearing in conducted by the notary over the video conference; and generate an e-notary journal data file for the e-notary, the e-notary journal data file based at least in part on the identity of the witness and the recording of the system audio track and the video.

In some embodiments, the computing device caused to verify the identity of a witness is further caused to input a primary contact information of the witness; send a prompt to the primary contact information of the witness to upload, or otherwise transmit, a photograph of an identification of the witness; receive the photograph of the identification of the witness; and store the identification of the witness in an encrypted format.

In some embodiments, the computing device caused to verify the identity of a witness is further caused to input a primary contact information of an attorney of the witness; send a prompt to the primary contact information of the attorney to provide an affirmation from the attorney of the identity of the witness; and receive the affirmation from the attorney of the identity of the witness.

In some embodiments, the computing device is further caused to send a prompt to the primary contact information of the attorney to upload, or otherwise transmit, a photograph of an identification of the attorney; receive the photograph of the identification of the attorney; and store the identification of the attorney in an encrypted format.

In some embodiments, the computing device caused to merge the first audio track of the witness and the second audio track of the notary to form the system audio track is further caused to match an audio tempo of each of the first audio track and the second audio track such that the first audio track and the second audio track are in sync.

In some embodiments, the computing device caused to record the system audio track and the video of the video conference for the swearing in of the witness is further caused to prompt the notary to record via a web browser; prompt the notary to select a screen comprising the video conference; record the screen comprising the video conference; and prompt the notary to stop recording via the web browser.

In some embodiments, the computing device is on a user device of the notary.

In some embodiments, the computing device caused to generate the e-notary journal data file for the e-notary is further caused to associate an encryption key with the e-notary journal data file; and store the e-notary journal data file in an encrypted format.

In some embodiments, the computing device is further caused to store time and date data associated with the e-notary journal data file; and provide a token to the notary to access the encrypted format to retrieve the e-notary journal data file.

In some embodiments, the computing device is further caused to receive information about the witness. The information about the witness comprises at least one of a first name, a last name, and a witness type. The e-notary journal data file comprises the information about the witness.

Embodiments also provide a non-transitory computer-readable storage medium having computer-executable instructions stored thereon for journalizing an e-notary. Executing the computer-executable instructions on a computing device causes the computing device to verify the identity of a witness; conduct a video conference between the witness and a notary; record a screen comprising the video conference for a swearing in of the witness, the swearing in conducted by the notary over the video conference; and generate an e-notary journal data file for the e-notary, the e-notary journal data file based at least in part on the identity of the witness and the recording of the screen comprising the video conference.

### DETAILED DESCRIPTION

It is to be understood that at least some of the figures and descriptions of the invention have been simplified to illustrate elements that are relevant for a clear understanding of the invention, while eliminating, for purposes of clarity, other elements that those of ordinary skill in the art will appreciate also comprise a portion of the invention. However, because such elements do not facilitate a better understanding of the invention, a description of such elements is not provided herein.

Notaries can perform several notarial actions, including signature verification. Another notarial action is verifying the identity of a witness being sworn in for a legal proceeding, such as a deposition. Such verifications have been traditionally conducted while the notary is in the physical vicinity of the witness. However, in virtual legal proceedings, notaries have been required to conduct such verifications while remote from the witness. Verifying a witness identification can be difficult while remote, as the witness must provide identification to the notary over user devices, networks, and video conferencing applications, which can inadequately support data transfer and validation of the identification.

Some jurisdictions may require notaries to qualify as e-notaries such that they can conduct verification activities remotely. Some jurisdictions can require e-notaries to create or maintain a notarial journal of a verification conducted remotely, or virtually, e.g., an e-notary. Some jurisdictions can require the notarial journal to include the identification of the witness, the identification being verified as authentic by an approved verification system. Some jurisdictions can require the notarial journal to include an audio recording of the e-notary. Some jurisdictions can also require the notarial journal to include a video recording of the e-notary. For example, the state of New York is a jurisdiction in which e-notaries must comply with statutory requirements for journalizing an e-notary.

Applicant has developed a novel method, apparatus, and computer-readable medium for journalizing an e-notary with computing devices that solves the above-mentioned problems and technical challenges. As discussed herein, journalizing an e-notary can include verifying the identity of the witness. The notary can request identification from a witness, the witness then being provided with a prompt to transmit their identification to the notary. The identification can be verified by an approved verification system, which can be internal or external to the computing device. Additionally or alternatively, an attorney for the witness can provide their identification to attest to the identification of the witness. The notary can conduct a swearing in of the witness for a legal proceeding over a video conference (such as a video deposition or a video hearing), the notary recording the video conference to journalize the swearing in notarial action. The computing device can sync the audio of the notary and the witness, if the respective systems require, to allow the notary to record an audio and a video of the video conference. An e-notary journal data file for the e-notary can be generated and maintained having the identity of the witness and the recording of the system audio track and the video.

The novel method, apparatus, and computer-readable medium will now be discussed with reference to the figures.

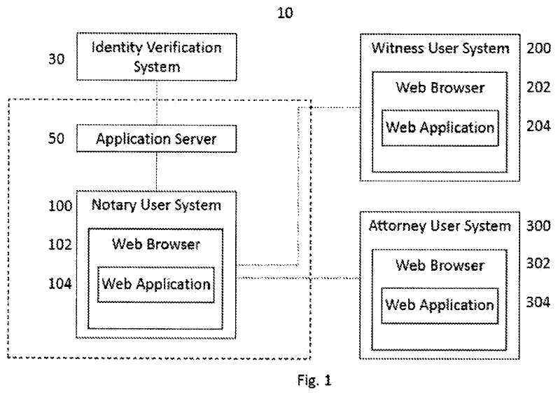

FIG. 1 discloses aspects of exemplary embodiments of an e-notary journalizing system 10 in accordance with this disclosure. E-notary journalizing system 10 can include an application server 50 and a notary user system 100. As discussed herein, e-notary journalizing system 10 can journalize an e-notary having, in part, an audio and video recording of a notary swearing in a witness for a legal proceeding. Notary user system 100 can be a user device of the notary, e.g., a desktop computer, a laptop computer, a specialized computer server, or an Internet enabled smartphone or tablet. Notary user system 100 is representative of any electronic device, or combination of electronic devices, capable of receiving information on a user interface and transmitting data files corresponding to e-notary journalizing.

Notary user system 100 can transfer data to application server 50 related to journalizing an e-notary. Application server 50 can store the data from notary user system 100, which can include one or more aspects of the e-notary, e.g., audio, video, and/or identification(s). In addition, application server 50 can store metadata associated with the e-notary. Application server 50 can be hosted on a cloud computing framework. Application server 50 can comprise, e.g., web server connectors, computer programming scripts, and data base connectors.

E-notary journalizing system 10 can also include an identity verification system 30. Identity verification system 30 can be based in part on a state of the art processor capable of receiving and analyzing data files related to identification to verify the validity of the identification. Identity verification system 30 can be an external system, or an off-the shelf system. E-notary journalizing system 10 can be configured to interact with the Regula™ API (application programming interface), for example. E-notary journalizing system 10 can be configured to interact with a plurality of identity verification systems 10, in another example, including Regula™. Alternatively, identity verification system 30 can be an internal system. Application server 50 can transfer identification data to identity verification system 30, for example, to request verification of the identification data, and thereby the identity, of a witness and/or an attorney of the witness. The identification data can be comprised by a driver's license, for example. Identity verification system 30 can transfer data to application server 50 to, for example, acknowledge the request, and provide verification or a verification rejection of the identity of the witness and/or the attorney.

With reference to FIG. 1 notary user system 100 can support a web browser 102. Web browser 102 can be a software system upon which web applications run. Web application 104 can be executed on web browser 102 to run one or more displays to facilitate journalizing an e-notary.

E-notary journalizing system 10 can also include a witness user system 200. Witness user system 200 can be a user device of a witness, e.g., a desktop computer, a laptop computer, a specialized computer server, or an Internet enabled smartphone or tablet. Witness user system 200 is representative of any electronic device, or combination of electronic devices, capable of receiving information on a user interface and transmitting data files corresponding to e-notary journalizing. Witness user system 200 can transfer data to notary user system 100 such as for identity verification of the witness.

Witness user system 200 can support a web browser 202. Web browser 202 can be a software system upon which web applications run. Web application 204 can be executed on web browser 202 to run one or more displays to facilitate journalizing an e-notary.

E-notary journalizing system 10 can also include an attorney user system 300. Attorney user system 300 can be a user device of an attorney of a witness, e.g., a desktop computer, a laptop computer, a specialized computer server, or an Internet enabled smartphone or tablet. Attorney user system 300 is representative of any electronic device, or combination of electronic devices, capable of receiving information on a user interface and transmitting data files corresponding to e-notary journalizing. Attorney user system 300 can transfer data to notary user system 100 such as for identity verification of the witness and/or the attorney.

Attorney user system 300 can support a web browser 302. Web browser 302 can be a software system upon which web applications run. Web application 304 can be executed on web browser 302 to run one or more displays to facilitate journalizing an e-notary.

While the exemplary embodiments depicted in FIG. 1 show identity verification system 30, application server 50, notary user system 100, witness user system 200, and attorney user system 300 as being operably connected, it should be noted that this is only one of many embodiments of an appropriate e-notary journalizing system 10. In other embodiments, each component of e-notary journalizing system 10 can be connected via a network. Examples of an appropriate network include, for example, a local area network (“LAN”), a wide area network (“WAN”) such as the Internet, or a combination of the two, and can include wired, wireless, or fiber optic connections. For example, the identity verification system 30, application server 50, notary user system 100, witness user system 200, and attorney user system 300 may be connected, directly or indirectly, to the Internet, and each of the systems may communicate, directly or indirectly, with any of the other systems. Additionally, in an alternative embodiment, identity verification system 30 and/or application server 50 can be housed on notary user system 100, if the system is to be deployed on a local computer, for example, or if identity verification system 30 and/or application server 50 are internal systems.

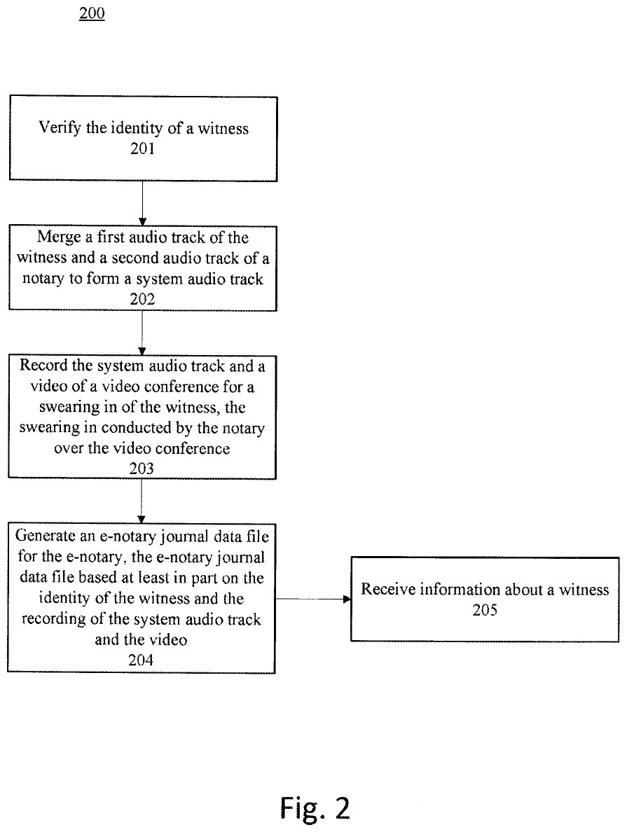

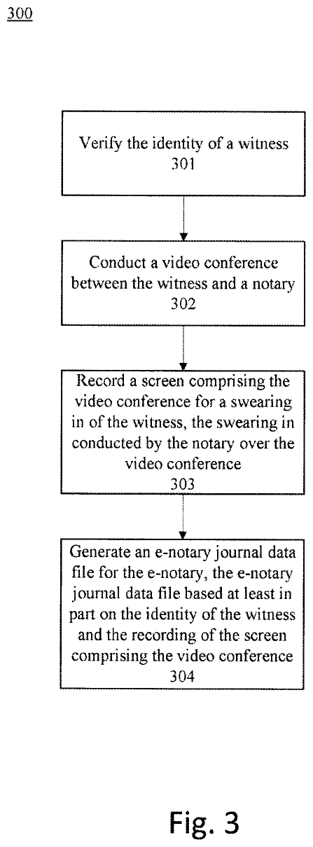

FIG. 2 discloses an exemplary method 200 for journalizing an e-notary in accordance with this disclosure. Method 200 can utilize one or more aspects of e-notary journalizing system 10 shown in FIG. 1. Method 200 can include one or more steps of method 300 shown in FIG. 3.

Method 200 for journalizing an e-notary can include a notary user system, e.g., notary user system 100 (FIG. 1), verifying 201 the identity of a witness. The identity can be verified by inputting, on the notary user system, e.g., via a web application, such as web application 104, a primary contact information of the witness, which can be a phone number or an email address, for example. A prompt can be sent to the primary contact information of the witness to upload, or otherwise transmit, a photograph of an identification of the witness, which can be used verify the identity of the witness. The prompt can be sent to a witness user system of the witness, e.g., witness user system 200 (FIG. 1), which can be a desktop computer, a laptop computer, a specialized computer server, or an Internet enabled smartphone or tablet. The prompt can be, for example, in the form of a text message, an email, or a push notification.

Verifying 201 the identity of the witness can include receiving from the witness user system an image, such as a photograph, of the identification of the witness, for example. The identification can be a driver's license, for example, and can be in the form of a document file, for example, .pdf, .txt, or .docx, or an image file, for example, .jpeg or .png. Alternatively, the identification can be another form of identification, such as a passport or a birth certificate, for example. The witness can upload, or otherwise transmit, the identification to the witness user system, e.g., via a web application, such as web application 204, which can then send the identification to the notary user system.

Verifying 201 the identity of the witness can include an application server, e.g., application server 50, storing the identification of the witness received on the notary user system in an encrypted format. The identification can be stored for a predetermined amount of time, e.g., between about one month to about ten years, such as between about one year to about seven years, such as about five years. In this way, the witness can be pre-verified and does not need to send their identification for subsequent notarial actions.

Verifying 201 the identity of the witness can include sending the identification of the witness to an identity verification system, e.g., identity verification system 30 (FIG. 1). The identity verification system can be an external system, for example, and can receive the identification of the witness from the application server. The identity verification system can confirm the validity of the identification. The identity verification system can verify the identity of the witness based on the identification of the witness being valid. To confirm the validity of the identification, the identity verification system can, for example, confirm the content of the identification matches content specific to a particular identification format, e.g., a specific jurisdiction's driver's license format. The identity verification system can also confirm the data on the identification to verify the identity of the witness.

The identification system can verify or reject the validity of the identification of the witness. If the validity of the identification of the witness is rejected, another identification of the witness can be validated, or the identity of the witness can be verified by alternative means, such as by verifying the identification of an attorney of the witness. In addition, verifying 201 the identity of the witness can bypass validating the identification of the witness by instead verifying the identification of the attorney of the witness.

Verifying 201 the identity of a witness can include inputting, on the notary user system, e.g., via a web application, such as web application 104, a primary contact information of an attorney of the witness, which can be a phone number or an email address, for example. A prompt can be sent to the primary contact information of the attorney. The prompt can be sent to an attorney user system, e.g., attorney user system 300 (FIG. 1), which can be a desktop computer, a laptop computer, a specialized computer server, or an Internet enabled smartphone or tablet. The prompt can be, for example, in the form of a text message, an email, or a push notification.

The prompt can be to provide an affirmation from the attorney of the identity of the witness. Verifying 201 the identity of the witness can include receiving from the attorney user system the affirmation from the attorney of the identity of the witness. The attorney can provide affirmation if the identity of the attorney is verified.

If the identity of the attorney is not verified, the prompt can be to upload, or otherwise transmit, an image, such as a photograph, of an identification of the attorney, which can be used verify the identity of the witness. Accordingly, verifying 201 the identity of the witness can include receiving from the attorney user system a photograph of the identification of the attorney, for example. The identification can be a driver's license, for example, and can be in the form of a document file, for example, .pdf, .txt, or .docx, or an image file, for example, .jpeg or .png. Alternatively, the identification can be another form of identification, such as a passport or a birth certificate, for example. The attorney can upload, or otherwise transmit, the identification to the attorney user system, e.g., via a web application, such as web application 304, which can then send the identification to the notary user system.

Verifying 201 the identity of the witness can include an application server, e.g., application server 50, storing the identification of the attorney received on the notary user system in an encrypted format. The identification of the attorney can be stored for a predetermined amount of time, e.g., between about one month to about ten years, such as between about one year to about seven years, such as about five years. In this way, the attorney can be pre-verified and does not need to send their identification for subsequent notarial actions.

Verifying 201 the identity of the witness can include sending the identification of the attorney to an identity verification system, e.g., identity verification system 30 (FIG. 1). The identity verification system can be an external system, for example, and can receive the identification of the attorney from the application server. The identity verification system can confirm the validity of the identification. The identity verification system can verify the identity of the witness based on the identification of the attorney being valid. To confirm the validity of the identification, the identity verification system can, for example, confirm the content of the identification matches content specific to a particular identification format, e.g., a specific jurisdiction's driver's license format. The identity verification system can also confirm the data on the identification to verify the identity of the witness. If the validity of the identification of the attorney is rejected, another identification of the attorney can be validated.

Method 200 for journalizing an e-notary can also include the notary user system merging 202 a first audio track of the witness and a second audio track of a notary to form a system audio track. In other words, method 200 can include merging an audio track of the notary user system and a separate audio track of the witness user system. Via the notary user system and the witness user system, the swearing in process of the witness can occur over a video conference, the swearing in conducted by the notary over the video conference. The audio tracks of each system can require merging if the audio tracks vary in tempo, length, or volume, for example. Without the merging, the playback of the recording in step 203 can be distorted. Merging 202 can occur after the identity of the witness is verified. In other embodiments, the video conference can include a common audio track and video that can be recorded without having to merge separate audio tracks and/or video.

Merging 202 can include matching an audio tempo of each of the first audio track and the second audio track such that the first audio track and the second audio track are in sync. The notary user system can also sync a video of the video conference with the first audio track and the second audio track. In this way, the audio and video of a swearing in conducted over a video conference can be accurately captured.

Method 200 for journalizing an e-notary can also include recording 203 the system audio track and a video of a video conference for a swearing in of the witness. The recording of the system audio track and the video of the video conference for the swearing in of the witness can be conducted on a user device of the notary, e.g., the notary user system. Accordingly, the notary via the notary user system can record the swearing in of the witness conducted by the notary over the video conference.

The recording can be conducted via a web browser on the notary user system, e.g., web browser 102. The recording can be started by an input by the notary on the notary user system. Recording 203 can include prompting the notary on the notary user system to record the video conference via the web browser. Recording 203 can also include prompting the notary on the notary user system to select a screen on the notary user system comprising the video conference. In this way, the video conference on which the swearing in is conducted can be recorded. Recording 203 can include recording the screen comprising the video conference. The recording of the screen can be ended by an input by the notary on the notary user system. Recording 203 can include prompting the notary to stop recording via the web browser.

Method 200 for journalizing an e-notary can include the notary user system generating 204 an e-notary journal data file for the e-notary, the e-notary journal data file based at least in part on the identity of the witness and the recording of the system audio track and the video. An e-notary journal data file can include global metadata, such as an e-notary journal file name, an e-notary journal file size, a date that the e-notary journal data file was uploaded, a date that the e-notary journal data file was updated, and/or other user applied labels and descriptors. While referenced as a file herein, the e-notary journal data file may be implemented with multiple files or one or more other data structures.

Generating 204 can include associating an encryption key with the e-notary journal data file. In this way, generating 204 can include storing the e-notary journal data file in an encrypted format. The e-notary journal data file can be stored in the application server, e.g., application server 50, for example. Additionally or alternatively, the e-notary journal data file can be stored locally on the notary user system. Metadata can be stored along with the e-notary journal data file. Accordingly, generating 204 can include storing time and date data associated with the e-notary journal data file. The e-notary journal data file can be included in a notarial journal of the notary. Accordingly, the e-notary journal data file can be accessible to the notary. Generating 204 can include providing a token to the notary to access the encrypted format to retrieve the e-notary journal data file.

Method 200 for journalizing an e-notary can include the notary user system receiving 205 information about the witness. The information about the witness can include at least one of a first name, a last name, and a witness type. The e-notary journal data file can include the information about the witness along with the metadata.

FIG. 3 discloses an exemplary method 300 for journalizing an e-notary in accordance with this disclosure. Method 300 can utilize one or more aspects of e-notary journalizing system 10 shown in FIG. 1. Method 300 can include one or more steps of method 200 shown in FIG. 2.

Method 300 for journalizing an e-notary can include a notary user system, e.g., notary user system 100, verifying 301 the identity of a witness. Verifying 301 can be similar to verifying 201 discussed above for method 200 in FIG. 2.

Method 300 for journalizing an e-notary can include the notary user system conducting 302 a video conference between a witness and a notary. As discussed above for method 200 in FIG. 2, via the notary user system and the witness user system, the swearing in process of the witness can occur over a video conference, the swearing in conducted by the notary over the video conference.

Method 300 for journalizing an e-notary can include the notary user system recording 303 a screen comprising the video conference for a swearing in of the witness, the swearing in conducted by the notary over the video conference. The video conference can include a common audio and video stream for the witness and the notary, which can be captured in recording 303. Recording 303 can be similar to recording 203 discussed above for method 200 in FIG. 2.

Method 300 for journalizing an e-notary can include the notary user system generating 304 an e-notary journal data file for the e-notary, the e-notary journal data file based at least in part on the identity of the witness and the recording of the system audio track and the video. Generating 304 can be similar to generating 204 discussed above for method 200 in FIG. 2.

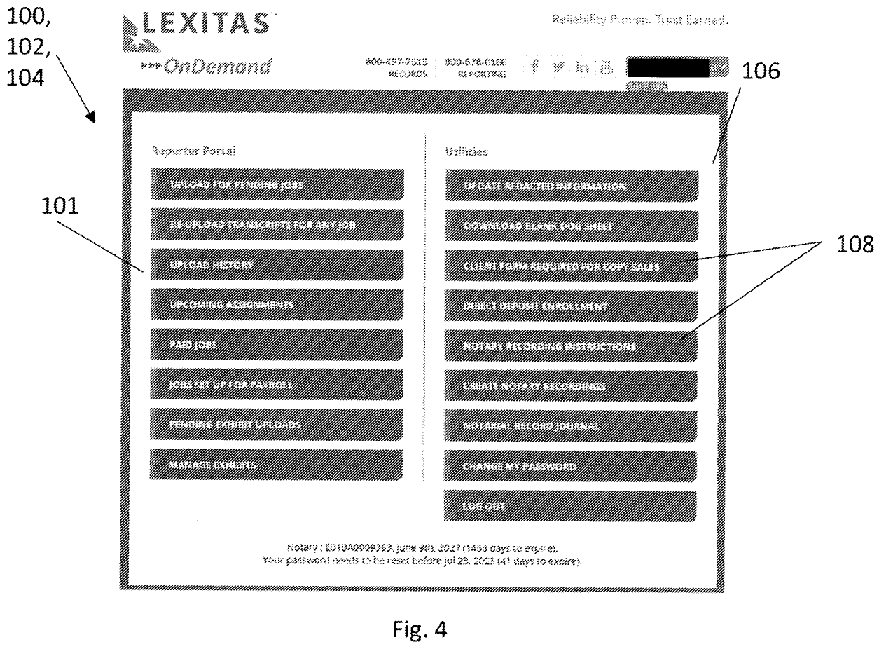

FIGS. 4-31 will now be described and show exemplary displays for the notary user system, e.g., notary user system 100 (FIG. 1), the witness user system, e.g., witness user system 200 (FIG. 1), and/or the attorney user system e.g., attorney user system 300 (FIG. 1), to execute one or more steps for journalizing an e-notary, such as via method 200 discussed above with reference to FIG. 2 and/or method 300 discussed above with reference to FIG. 3.

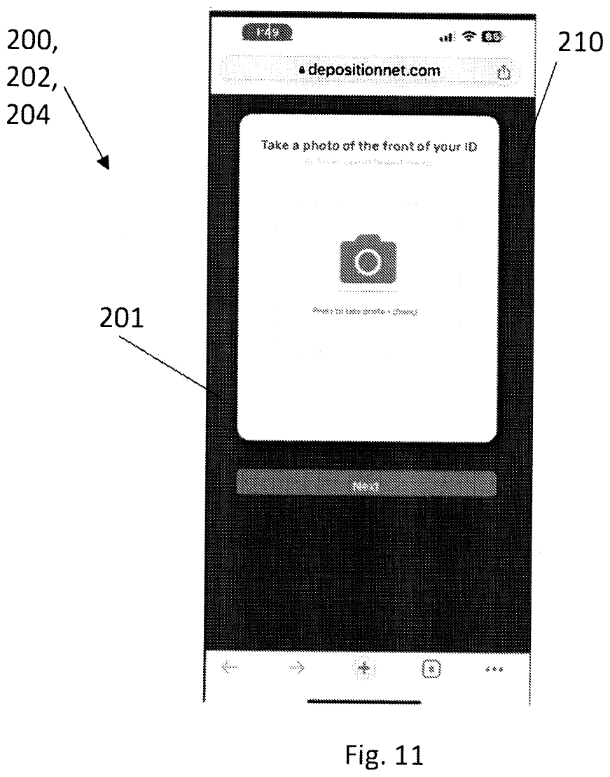

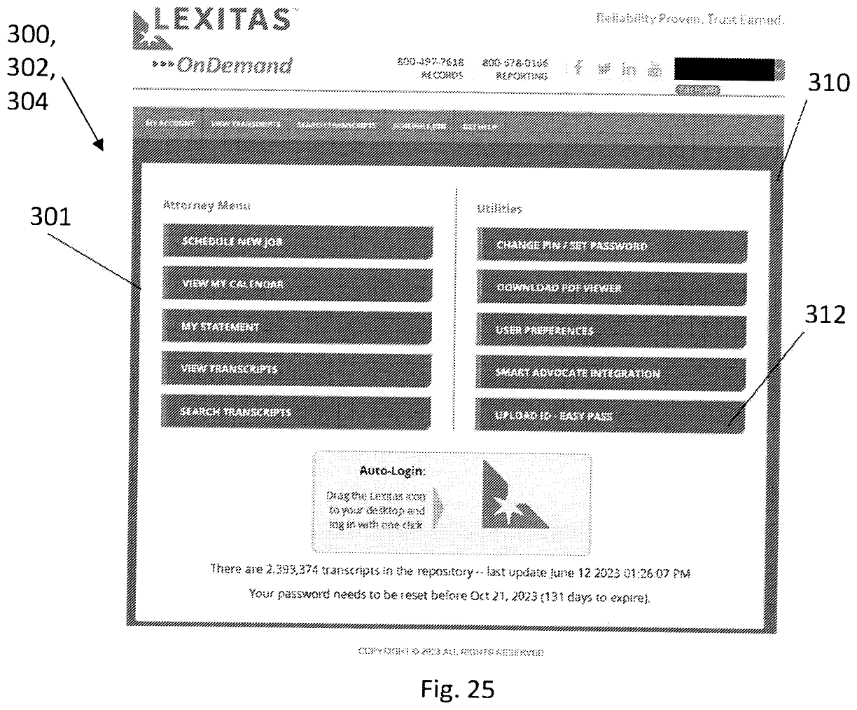

FIG. 4 is an exemplary display 106 of a notary user system user interface 111 for the notary user system. Display 106 can be one of a plurality of displays, or pages, of user interfaces, of notary user system user interface 111. These displays can be, for example, web pages or displays within web application 104, or another application or other software program. Embodiments can optionally display multiple pages simultaneously on different parts of a screen, or across multiple screens. Similarly, the witness user system can support a witness user system user interface 211 (FIG. 11) having one or more displays, and the attorney user system can support an attorney user system user interface 311 (FIG. 25) having one or more displays.

Display 106 can be generated by e-notary journalizing system 10 and displayed on a web application 104 deployed on a web browser 102 of a notary user system 100, of e-notary journalizing system 10, consistent with this disclosure. In various embodiments, a display 106 includes one or more menu buttons 108.

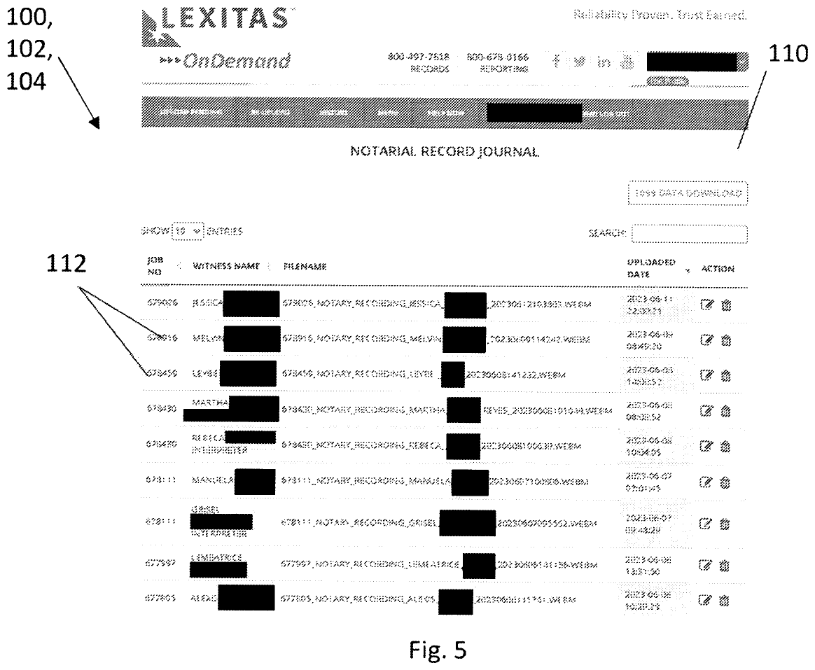

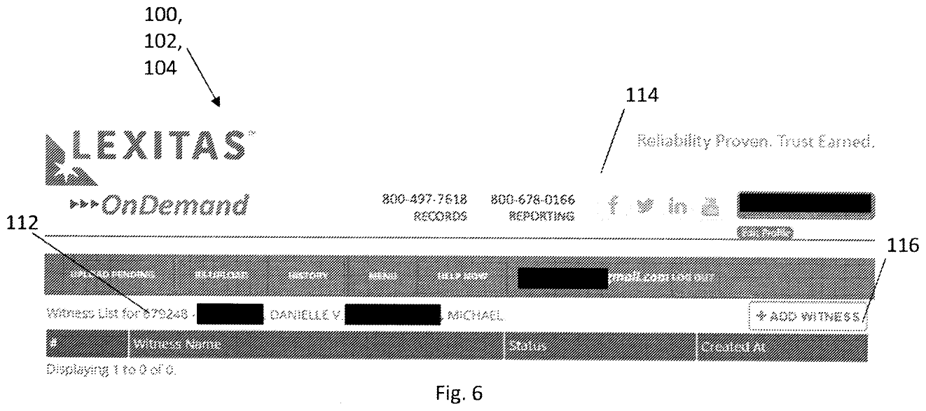

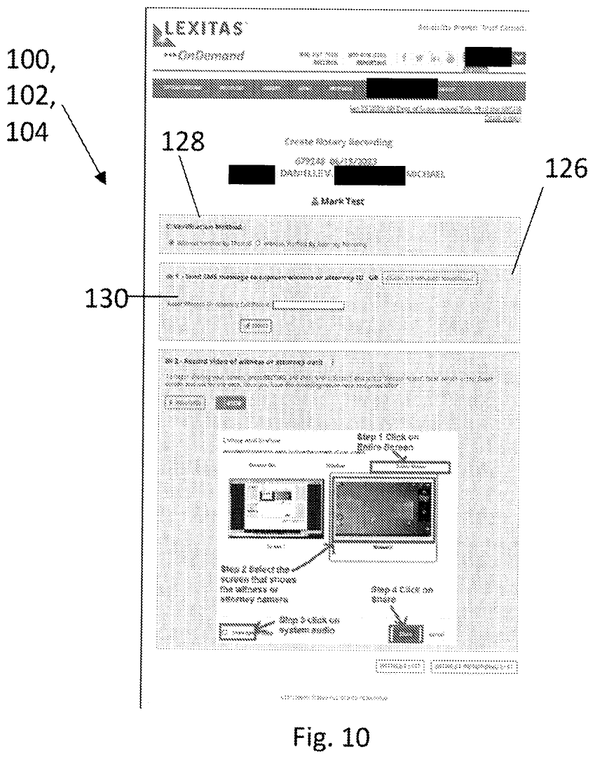

One or more menu buttons 108 can include at least one heading button allowing a user to select one or more heading buttons to navigate to a corresponding display of notary user system user interface 111. In various embodiments, menu buttons 108 can include “Create Notary Recording” and “Notarial Record Journal,” among other menu buttons 108. In such embodiments, web application 104 may, in response to an input from a user on notary user system 100, navigate a user, e.g., a notary, to a corresponding display of notary user system user interface 111. For example, a user input selecting “Notarial Record Journal” can navigate a user to a notarial record journal page, e.g., display 110 (FIG. 5) and a user input selecting “Create Notary Recording” can navigate as user to create notary recording user pages, e.g., display 112, 126 (FIGS. 6, 10).

FIG. 5 is an exemplary display 110 of a notarial record journal user interface consistent with this disclosure. Display 110 can include one or more jobs 112 that form the notarial record journal for the notary. Jobs 112 can refer to each legal proceeding in which the notary is performing a notarial action. Some jobs 112 can be listed more than once, such as if the notary performed multiple notarial actions for a particular job 112. For example, in one job 112, the notary can swear in multiple witnesses. Accordingly, the notarial record journal can list a job 112 multiple times, each entry associated with a different witness swear in. In this way, each job 112 can be listed by notarial record. As shown, notarial records can include file names and upload, or otherwise transmit, dates, or other metadata.

FIG. 6 is an exemplary display 114 of a witness list and add witness user interface consistent with this disclosure. One or more witnesses can be added for each job 112, such as jobs 112 shown in FIG. 5. Display 114 can be shown in response to selecting a particular job 112. Display 114 can include at least one button allowing a user to perform a corresponding action. As shown, display 114 can include an “Add Witness” button 116. Corresponding actions can add a witness, which can then be displayed in the witness list for the noted job 112.

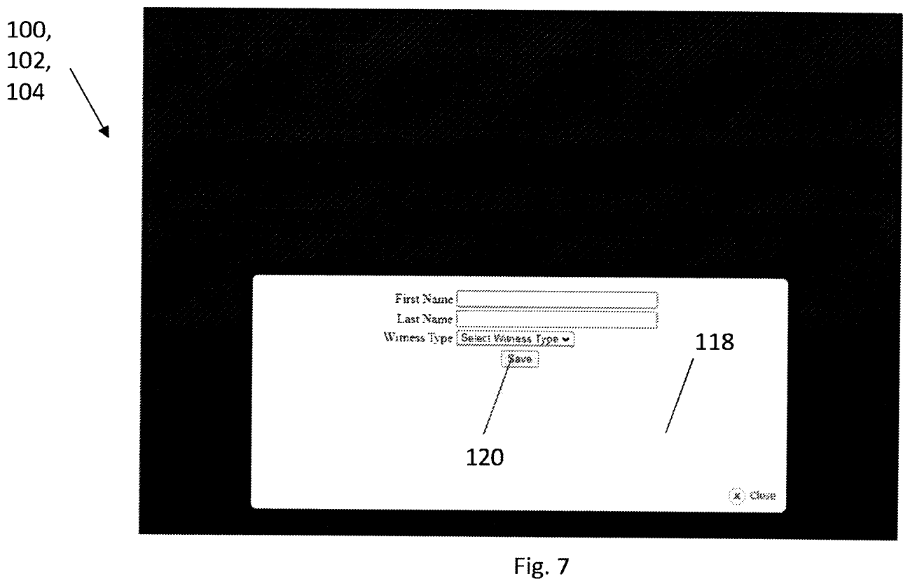

FIG. 7 is an exemplary display 118 of an add witness information user interface consistent with this disclosure. Display 118 can be shown in response to selecting the “Add Witness” button 116 in FIG. 6, for example. Information about the witness can be inputted, such as a first name a last name, and a witness type, e.g., plaintiff, defendant, etc.

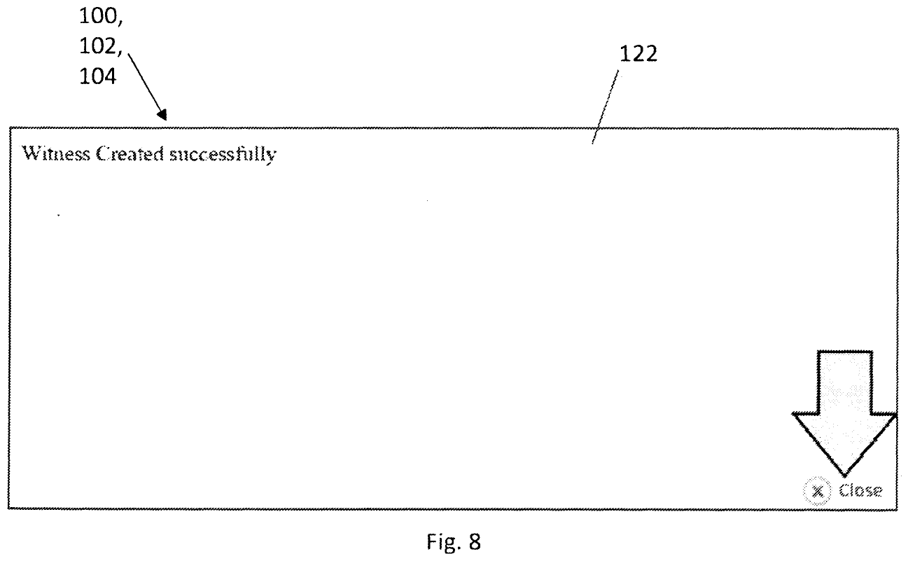

FIG. 8 is an exemplary display 122 of an add witness information confirmation user interface consistent with this disclosure. Display 122 can be shown in response to adding information about the witness and selecting “Save” 120 in display 118 shown in FIG. 7. Display 122 can confirm the witness for a job 112 (FIGS. 6-7) is created successfully, providing a user, e.g., the notary, with confirmation feedback.

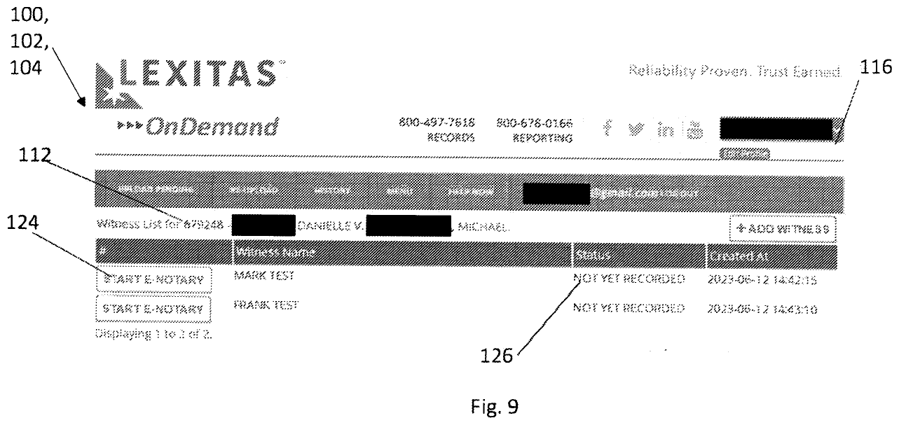

FIG. 9 is an exemplary display 116 of the witness list and add witness user interface consistent with this disclosure. As shown, the witness is populated in display 116 for a job 112. A status indicator 126 is provided for the witness to notify a user, e.g., a notary, whether or not the notarial action, e.g., a recording of a swearing in of the witness, for the witness has been completed. If the notarial action is not completed, status indicator 126 can recite “Not Yet Recorded.” Display 116 can include at least one button allowing a user to perform a corresponding action. As shown, display 116 can include a “Start E-Notary” button 124. Corresponding actions can facilitate completing the notarial action, which can then be displayed for the noted witness in display 116. In this way, display 116 can show a witness recording list.

FIG. 10 is an exemplary display 126 of a witness verification user interface consistent with this disclosure. A user, e.g., the notary, can complete a notarial action via display 126, where the notarial action is to conduct a recording of a swearing in of the witness. The identity of the witness can be verified before the witness is sworn in. The witness can be pre-verified, or can be verified by providing an identification or by their attorney providing an identification. A “Verification Method” menu interface 128 can allow the user to select a verification method to verify the identity of the witness. The witness can be verified by providing their identification by selecting “Witness Verified By Their ID.” The witness can alternatively be verified by an attorney of the witness attesting to the identity of the witness by selecting “Witness Verified By Attorney Attesting.” As shown, “Witness Verified By Their ID” is selected. Accordingly, the witness can provide their identification to verify their identity. A “Send SMS message to capture witness or attorney ID” menu interface 130 is shown on display 126. Menu interface 130 can be a prompt to the user to input the primary contact information for the witness. The user can input the phone number of the witness to allow the witness to provide their identification for verification. In alternative embodiments, an email address can be inputted for the witness to allow the witness to provide their identification for verification.

FIG. 11 is an exemplary display 210 of a capture witness identification user interface consistent with this disclosure. Display 210 can be on a witness user system. As shown, the witness can be prompted to add a photo of the front of an identification of the witness.

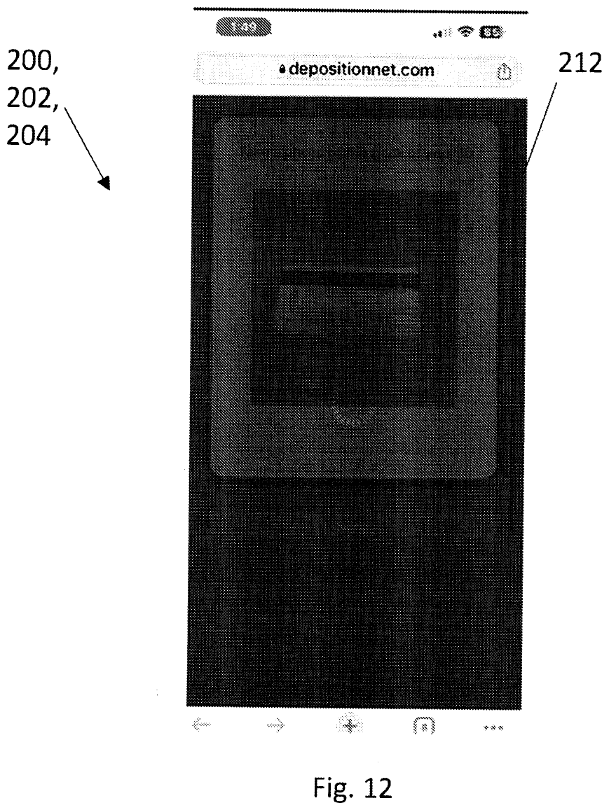

FIG. 12 is an exemplary display 212 of the capture witness identification user interface consistent with this disclosure. Display 212 can be on a witness user system. As shown, the witness can be prompted to add a photo of the back of the identification of the witness.

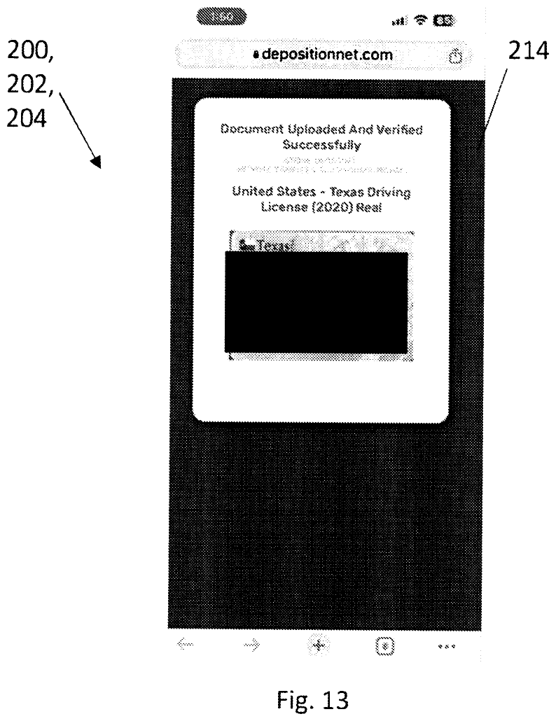

FIG. 13 is an exemplary display 214 of the capture witness identification user interface consistent with this disclosure. Display 214 can be on a witness user system. The identification, once captured, can be transmitted to an application server, e.g., application server 50 (FIG. 1), which can then transmit the identification to an identity verification system, e.g., identity verification system 30 (FIG. 1), to verify the validity of the identification. As shown, a user, e.g., the witness, can be provided with a confirmation that their identification was uploaded and verified successfully. The user can be prompted to add another identification if the verification fails.

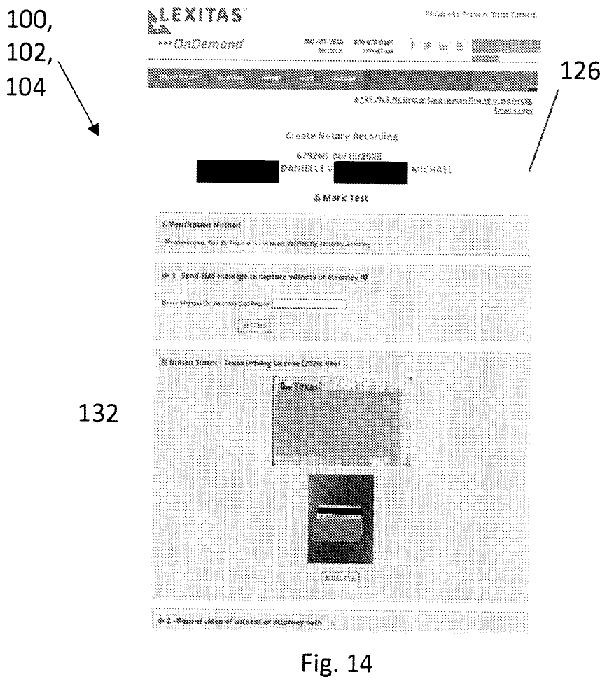

FIG. 14 is an exemplary display 126 of the witness verification user interface consistent with this disclosure. As shown, interface 132 on display 126 indicates the identification of the witness is provided and verified. Accordingly, a user, e.g., the notary, can proceed to complete a notarial action, such as swearing in the witness.

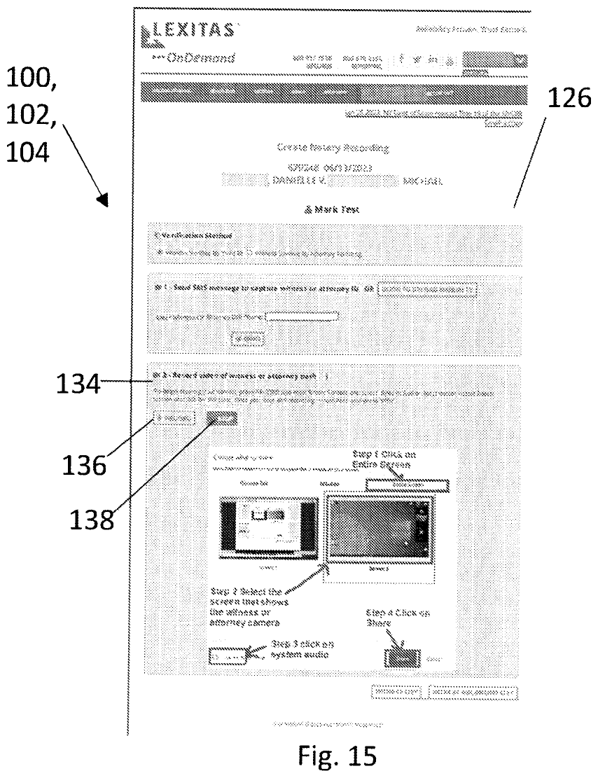

FIG. 15 is an exemplary display 126 of the witness verification user interface consistent with this disclosure. An interface 134 on display 126 can facilitate recording the video of the witness oath after the identification of the witness is verified, the oath being a notarial action that can be journalized via the recording. As shown, interface 134 can include at least one button allowing a user, e.g., the notary, to perform a corresponding action to facilitate completing the notarial action. As shown, display 126 can include a “Record” button 136 and a “Stop” button 138.

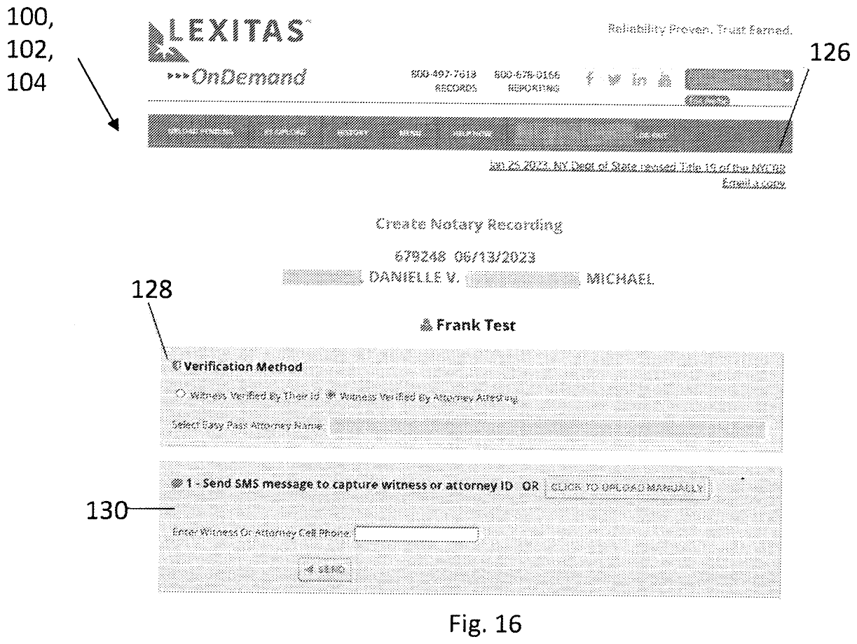

FIG. 16 is an exemplary display 126 of the witness verification user interface consistent with this disclosure. As discussed above, a user, e.g., the notary, can complete a notarial action via display 126, where the notarial action is to conduct a swearing in of the witness. The identity of the witness can be verified before the witness is sworn in. “Verification Method” menu interface 128 can allow the user to select a verification method to verify the identity of the witness. The witness can be verified by providing their identification by selecting “Witness Verified By Their ID.” The witness can alternatively be verified by an attorney of the witness attesting to the identity of the witness by selecting “Witness Verified By Attorney Attesting.” As shown, “Witness Verified By Attorney Attesting” is selected. Accordingly, the attorney can provide their identification to verify their identity. Menu interface 130 can be a prompt to the user to input the primary contact information for the attorney. The user can input the cell phone number of the attorney to allow the attorney to provide their identification for verification. In alternative embodiments, an email address can be inputted for the attorney to allow the attorney to provide their identification for verification.

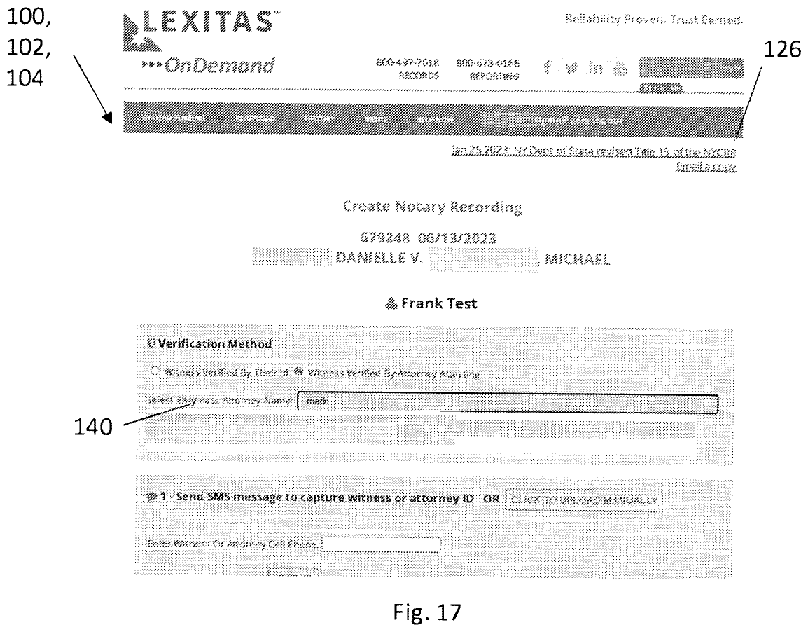

FIG. 17 is an exemplary display 126 of the witness verification user interface consistent with this disclosure. The identification of an attorney of the witness can be stored in the application server. In this way, the attorney does not need to upload, or otherwise transmit, their identification each time they attest to the identity of the witness. The identification of a witness can also be stored in the application server, such as if the witness is an expert witness or part of a lengthy trial, to avoid the witness having to upload, or otherwise transmit, their identification each time they provide an oath. In this way, the attorney or the witness can be pre-verified. To access stored identifications that are verified by the identity verification system, the attorney or witness can be searched via the “Easy Pass” search bar 140. Search bar 140 can allow a user, e.g., the notary, to execute a keyword search of one or more of an attorney or witness.

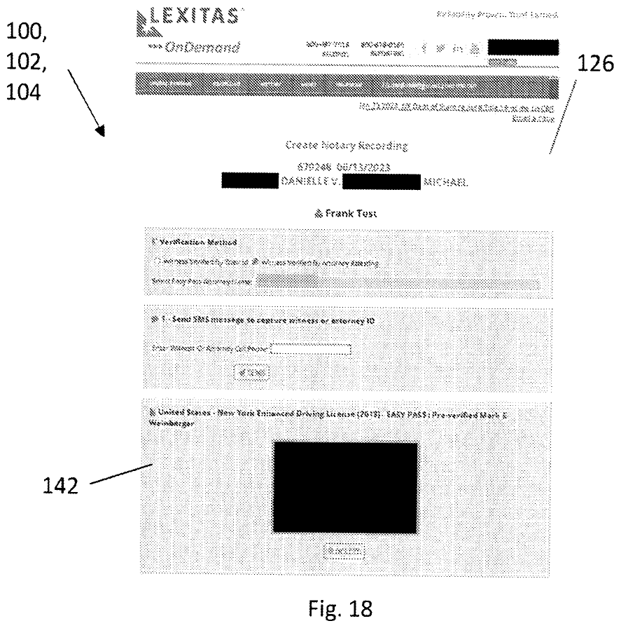

FIG. 18 is an exemplary display 126 of the witness verification user interface consistent with this disclosure. As shown, interface 142 on display 126 indicates the identification of the attorney is provided and verified. Interface 142 further indicates the attorney was pre-verified. The attorney can attest to the identification of a witness if the identification of the attorney is verified. Accordingly, a user, e.g., the notary, can proceed to complete a notarial action, such as swearing in the witness.

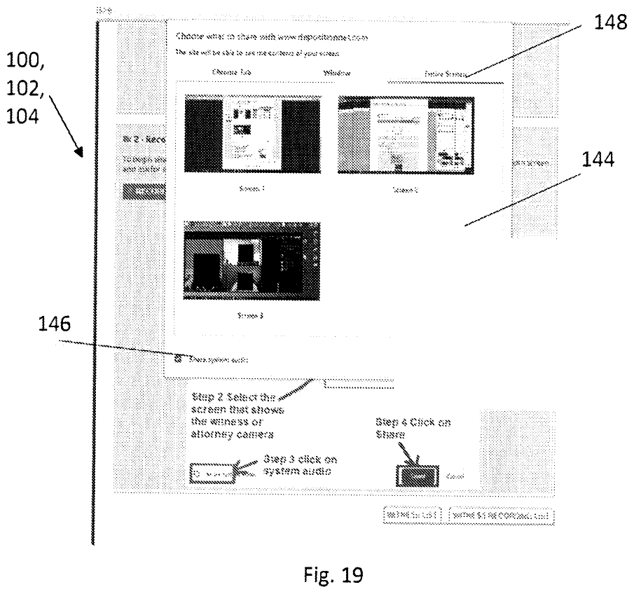

FIG. 19 is an exemplary display 144 of the witness verification user interface consistent with this disclosure. The user, e.g., the notary, can record a swearing in of a witness after the identification of the witness is verified. The recording can be included in the notary's notarial journal. Display 144 can be shown to facilitate recording of the swearing in. Display 144 can be shown after selecting the “Record” button 136 on display 126, shown in FIG. 15. The user can select “share system audio” 146, “Entire Screen” 148, and the screen comprising a video conference between the notary and the witness to record the swearing in. Selecting “share system audio” 146 can facilitate merging a first audio track of the witness and a second audio track of a notary to form a system audio track. In other words, an audio track of the notary user system and a separate audio track of the witness user system can be merged via “share system audio” 146. The audio tracks of each system can require merging if the audio tracks vary in tempo, length, or volume, for example. Without the merging, the playback of the recording can be distorted. In other embodiments, the video conference can include a common audio track and video that can be recorded without having to merge separate audio tracks and/or video.

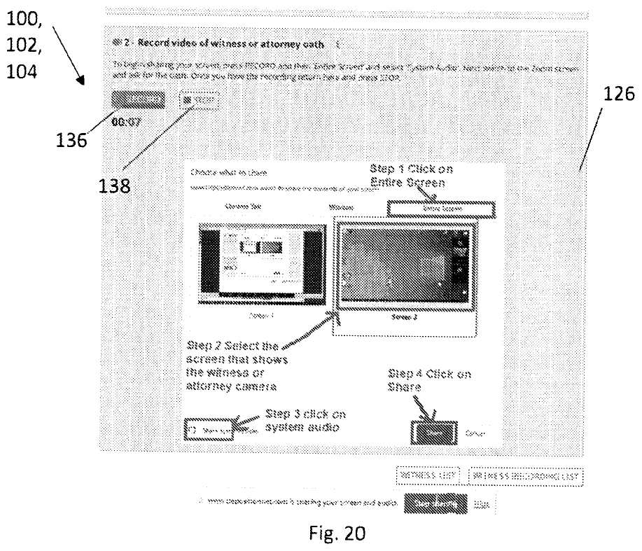

FIG. 20 is an exemplary display 126 of the witness verification user interface consistent with this disclosure. As shown, a timestamp can be shown indicating that a recording is in progress. After selecting the “Stop” button 138 on display 126, the recording can be ended.

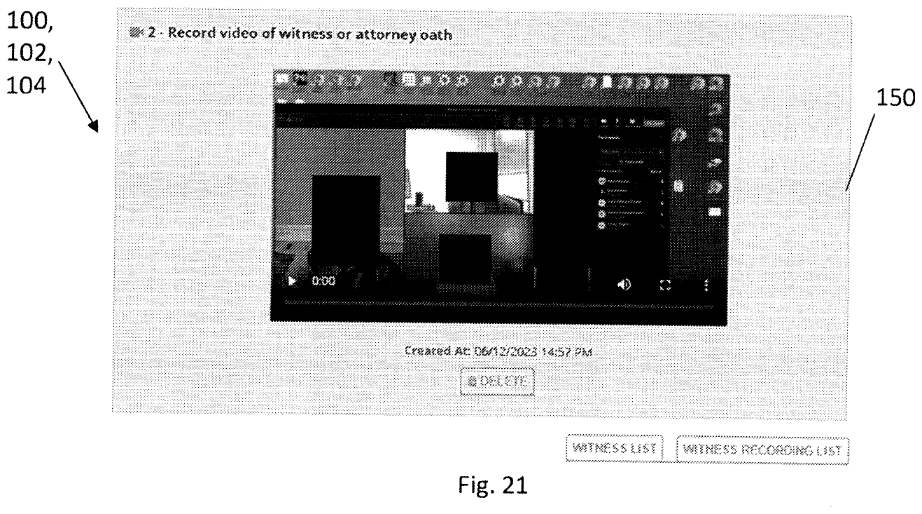

FIG. 21 is an exemplary display 150 of the witness verification user interface consistent with this disclosure. A preview of the recording of the swearing in can be shown. The recording can be deleted if a user, e.g., the notary, chooses to record a new recording.

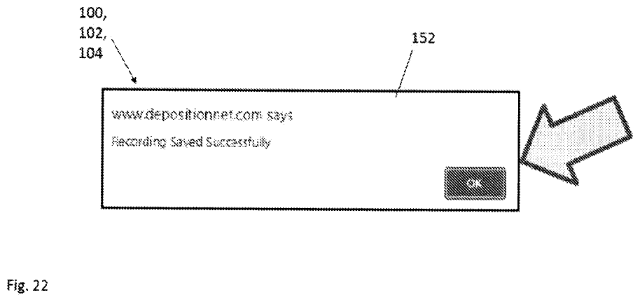

FIG. 22 is an exemplary display 152 of a recording save confirmation user interface consistent with this disclosure. Display 152 can confirm the recording is saved successfully, providing a user, e.g., the notary, with confirmation feedback.

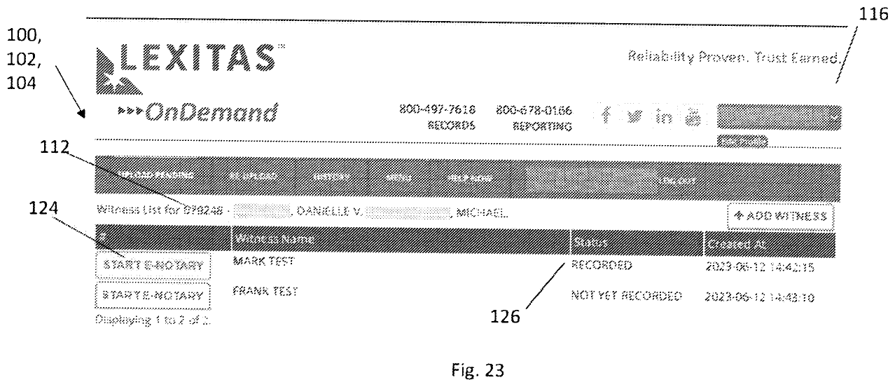

FIG. 23 is an exemplary display 116 of the witness list and add witness user interface consistent with this disclosure. As shown, the saved recording is associated with the witness populated in display 116 for a job 112. A status indicator 126 is provided for the witness to notify a user, e.g., a notary, whether or not the notarial action, e.g., a recording of a swearing in of the witness, for the witness has been completed. As the notarial action is completed, e.g., a recording of the swearing in of the witness is saved, status indicator 126 can recite “Recorded.”

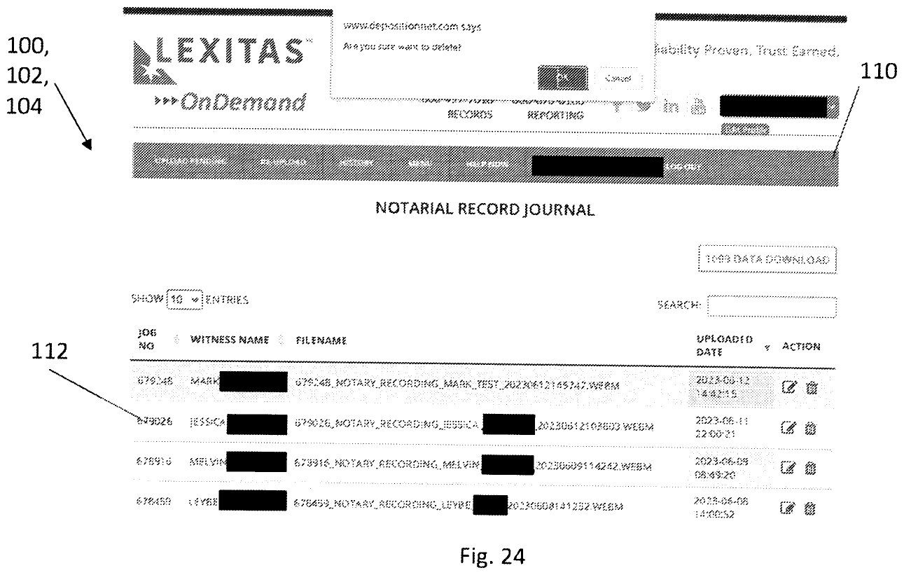

FIG. 24 is an exemplary display 110 of the notarial record journal user interface consistent with this disclosure. The recording can be shown associated with a job 112 listed as part of the notarial record journal for the notary. The recording can additionally be deleted on this page.

FIG. 25 is an exemplary display 310 of an attorney user interface consistent with this disclosure. Display 310 can include at least one button allowing a user, e.g., an attorney, to navigate to a corresponding display of a user interface of attorney user system user interface 311.

As shown, display 310 can include an “Upload, or otherwise transmit, ID-Easy Pass” button 312, among other buttons. Corresponding actions can navigate to displays to add an identification of the attorney that can be verified such that the attorney is pre-verified.

Accordingly, the attorney can bypass having to provide their identification each time they attest to the identity of a witness.

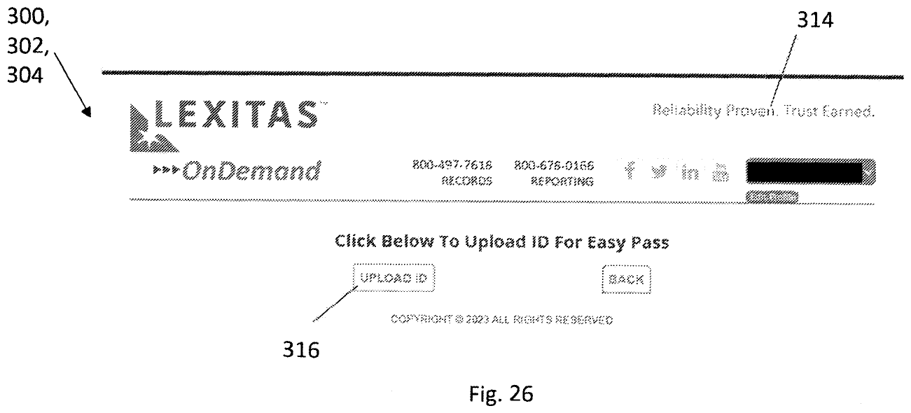

FIG. 26 is an exemplary display 314 of an easy pass user interface consistent with this disclosure. Display 314 can be shown after selecting the “Upload, or otherwise transmit, ID—Easy Pass” button 312 on display 310, shown in FIG. 25. In display 314, an “Upload, or otherwise transmit, ID” button 316 can be included. Selecting “Upload, or otherwise transmit, ID” button 316 can allow a user, e.g., an attorney to perform a corresponding action. “Upload, or otherwise transmit, ID” button 316 can facilitate adding an identification of the attorney that can be validated.

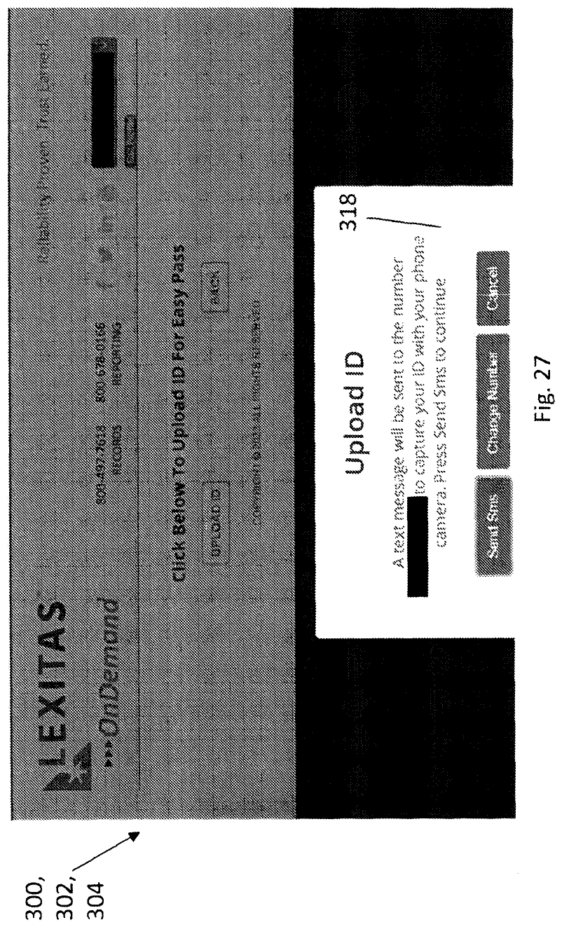

FIG. 27 is an exemplary display 318 of the easy pass user interface consistent with this disclosure. A user, e.g., the attorney, can provide their identification to be validated such that the attorney is pre-verified. Similar to in display 126 shown in FIG. 10, in display 318, the attorney can choose to “Send Sms,” or a text message, to a phone number on record, or provide a phone number. By selecting “Change Number” the attorney can provide or change a phone number.

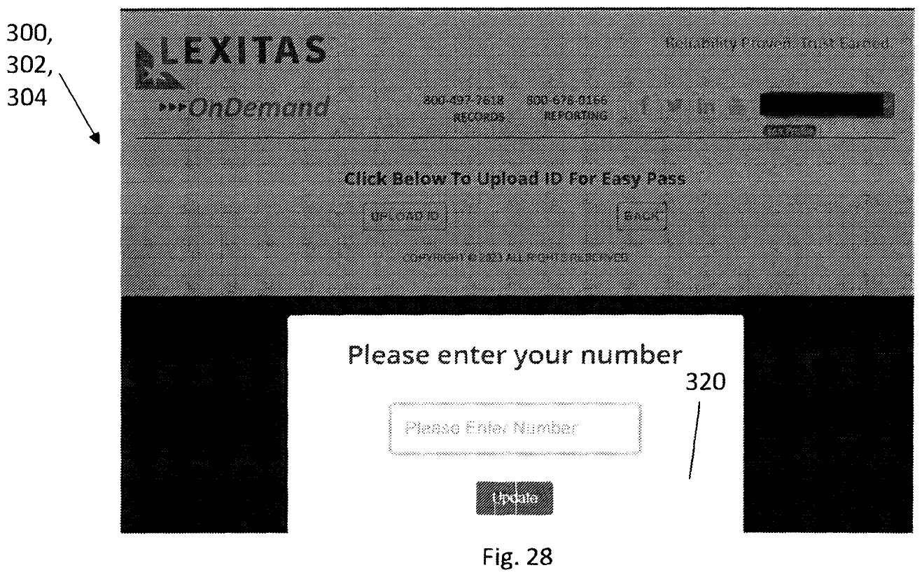

FIG. 28 is an exemplary display 320 of the easy pass user interface consistent with this disclosure. Display 320 can prompt a user, e.g., the attorney, to input the primary contact information for the attorney. The user can input the phone number of the attorney to allow the attorney to provide their identification for verification. In alternative embodiments, an email address can be inputted for the attorney to allow the attorney to provide their identification for verification.

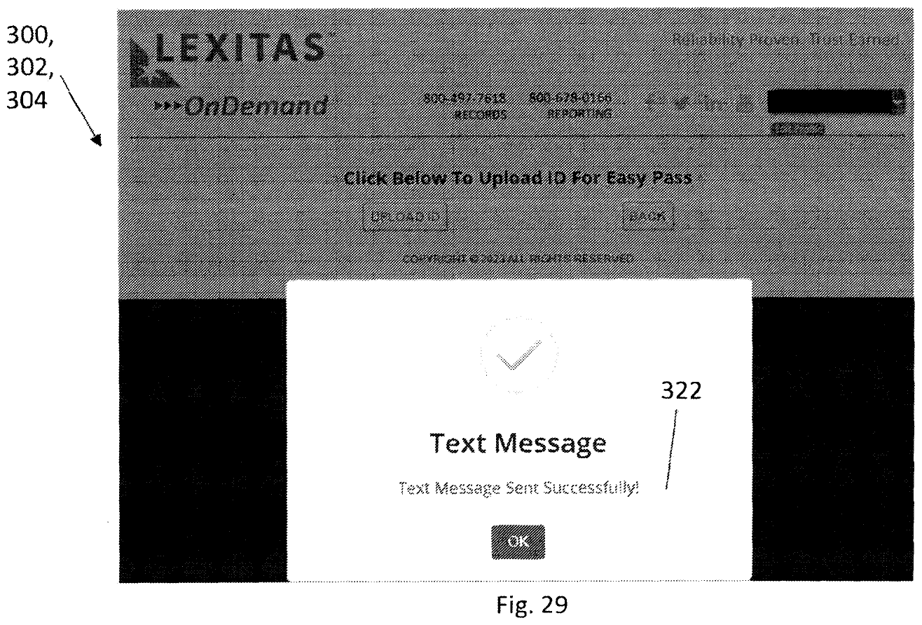

FIG. 29 is an exemplary display 322 of the easy pass user interface consistent with this disclosure. Display 322 can be shown in response to sending a text message via display 318 shown in FIG. 27. Display 122 can confirm the text message was sent successfully, providing a user, e.g., the attorney, with confirmation feedback.

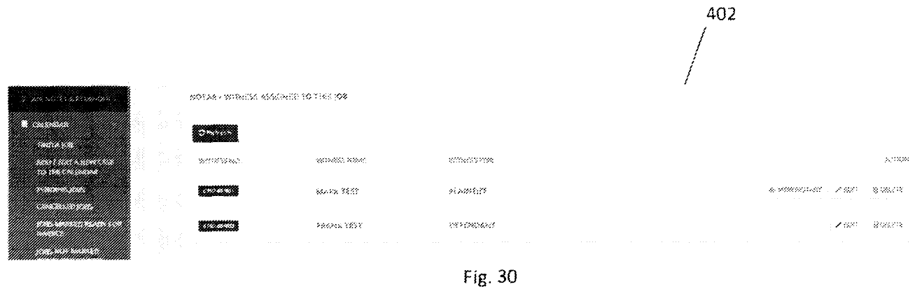

FIG. 30 is an exemplary display 402 of a backend user interface consistent with this disclosure. As shown, jobs for a notary, e.g., jobs 112 (FIG. 5) can be shown. Witnesses for a job can be listed along with actions to view the notary that conducted a notarial action with respect to the witness, edit the notarial action, and delete the notarial action. Display 402 can be accessible to a user, e.g., a notary.

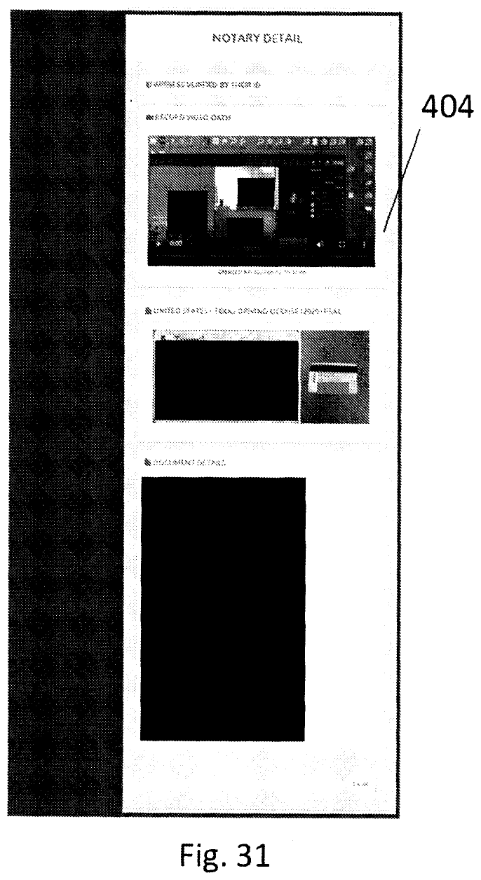

FIG. 31 is an exemplary display 404 of a backend user interface consistent with this disclosure. In display 404, details of documents listed for a notarial record can be viewed, for example, data on an identification or a recording of an oath. Display 404 can be accessible to a user, e.g., a notary.

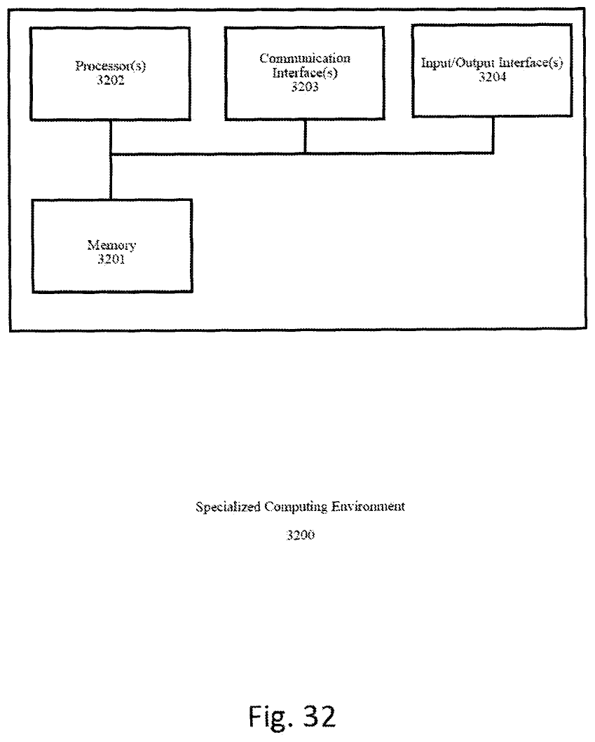

FIG. 32 illustrates the components of a specialized computing environment 3200 configured to perform the specialized processes described herein. Specialized computing environment 3200 is a computing device that includes a memory 3201 that is a non-transitory computer-readable medium and can be volatile memory (e.g., registers, cache, RAM), non-volatile memory (e.g., ROM, EEPROM, flash memory, etc.), or some combination of the two.

Memory can include a plurality of software components, with each of the software components in memory storing specialized instructions and data structures configured to perform the corresponding functionality and techniques described herein.

All of the software stored within memory 3201 can be stored as a computer-readable instructions, that when executed by one or more processors 3202, cause the processors to perform the functionality described with respect to FIGS. 1-31.

Processor(s) 3202 execute computer-executable instructions and can be a real or virtual processors. In a multi-processing system, multiple processors or multicore processors can be used to execute computer-executable instructions to increase processing power and/or to execute certain software in parallel.

Specialized computing environment 3200 additionally includes a communication interface 3203, such as a network interface, which is used to communicate with devices, applications, or processes on a computer network or computing system, collect data from devices on a network, and implement encryption/decryption actions on network communications within the computer network or on data stored in databases of the computer network. The communication interface conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Specialized computing environment 3200 further includes input and output interfaces 1304 that allow users (such as system administrators) to provide input to the system to set parameters, to edit data stored in memory 3201, or to perform other administrative functions.

An interconnection mechanism (shown as a solid line in FIG. 32), such as a bus, controller, or network interconnects the components of the specialized computing environment 1300.

Input and output interfaces 3204 can be coupled to input and output devices. For example, Universal Serial Bus (USB) ports can allow for the connection of a keyboard, mouse, pen, trackball, touch screen, or game controller, a voice input device, a scanning device, a digital camera, remote control, or another device that provides input to the specialized computing environment 3200.

Specialized computing environment 3200 can additionally utilize a removable or non-removable storage, such as magnetic disks, magnetic tapes or cassettes, CD-ROMs, CD-RWs, DVDs, USB drives, or any other medium which can be used to store information and which can be accessed within the specialized computing environment 3200.

Having described and illustrated the principles of our invention with reference to the described embodiment, it will be recognized that the described embodiment can be modified in arrangement and detail without departing from such principles. It should be understood that the programs, processes, or methods described herein are not related or limited to any particular type of computing environment, unless indicated otherwise. Elements of the described embodiment shown in software can be implemented in hardware and vice versa.

It will be appreciated by those skilled in the art that changes could be made to the embodiments described above without departing from the broad inventive concept thereof. For example, the steps or order of operation of one of the above-described methods could be rearranged or occur in a different series, as understood by those skilled in the art. It is understood, therefore, that this disclosure is not limited to the particular embodiments disclosed, but it is intended to cover modifications within the spirit and scope of the present disclosure.

What is claimed is:

1. A method for journalizing, by a computing device, an e-notary, the method comprising:
verifying, by the computing device, the identity of a witness;
merging, by the computing device, a first audio track of the witness and a second audio track of a notary to form a system audio track;
recording, by the computing device, the system audio track and a video of a video conference for a swearing in of the witness, the swearing in conducted by the notary over the video conference; and
generating, by the computing device, an e-notary journal data file for the e-notary, the e-notary journal data file based at least in part on the identity of the witness and the recording of the system audio track and the video.

2. A method for journalizing, by a computing device, an e-notary, the method comprising:
verifying, by the computing device, the identity of a witness;
conducting, by the computing device, a video conference between the witness and a notary;
recording, by the computing device, a screen comprising the video conference for a swearing in of the witness, the swearing in conducted by the notary over the video conference; and
generating, by the computing device, an e-notary journal data file for the e-notary, the e-notary journal data file based at least in part on the identity of the witness and the recording of the screen comprising the video conference.

3. The method of claim 1, wherein verifying, by the computing device, the identity of the witness comprises:
inputting, by the computing device, a primary contact information of the witness;
sending, by the computing device, a prompt to the primary contact information of the witness to upload, or otherwise transmit, a photograph of an identification of the witness;
receiving, by the computing device, the photograph of the identification of the witness; and
storing, by the computing device, the identification of the witness in an encrypted format.

4. The method of claim 1, wherein the verifying, by the computing device, the identity of the witness comprises:
inputting, by the computing device, a primary contact information of an attorney of the witness;
sending, by the computing device, a prompt to the primary contact information of the attorney to provide an affirmation from the attorney of the identity of the witness; and
receiving, by the computing device, the affirmation from the attorney of the identity of the witness.

5. The method of claim 4, further comprising:
sending, by the computing device, a prompt to the primary contact information of the attorney to upload, or otherwise transmit, a photograph of an identification of the attorney;
receiving, by the computing device, the photograph of the identification of the attorney; and
storing, by the computing device, the identification of the attorney in an encrypted format.

6. The method of claim 1, wherein the merging, by the computing device, the first audio track of the witness and the second audio track of the notary to form the system audio track comprises:
matching, by the computing device, an audio tempo of each of the first audio track and the second audio track such that the first audio track and the second audio track are in sync.

7. The method of claim 1, wherein the recording, by the computing device, the system audio track and the video of the video conference for the swearing in of the witness comprises:
prompting, by the computing device, the notary to record via a web browser;
prompting, by the computing device, the notary to select a screen comprising the video conference;
recording, by the computing device, the screen comprising the video conference; and
prompting, by the computing device, the notary to stop recording via the web browser.

8. The method of claim 1, wherein the recording of the system audio track and the video of the video conference for the swearing in of the witness is conducted on a user device of the notary.

9. The method of claim 1, wherein the generating, by the computing device, the e-notary journal data file for the e-notary comprises:
associating, by the computing device, an encryption key with the e-notary journal data file; and
storing, by the computing device, the e-notary journal data file in an encrypted format.

10. The method of claim 9, further comprising:
storing, by the computing device, time and date data associated with the e-notary journal data file; and
providing, by the computing device, a token to the notary to access the encrypted format to retrieve the e-notary journal data file.

11. The method of claim 1, further comprising:
receiving, by the computing device, information about the witness,
wherein the information about the witness comprises at least one of a first name, a last name, and a witness type, and
wherein the e-notary journal data file comprises the information about the witness.

12. A system for journalizing an e-notary, the system comprising a computing device configured to:
verify the identity of a witness;
merge a first audio track of the witness and a second audio track of a notary to form a system audio track;
record the system audio track and a video of a video conference for a swearing in of the witness, the swearing in conducted by the notary over the video conference; and
generate an e-notary journal data file for the e-notary, the e-notary journal data file based at least in part on the identity of the witness and the recording of the system audio track and the video.

13. A system for journalizing an e-notary, the system comprising a computing device configured to:
verify the identity of a witness;
conduct a video conference between the witness and a notary;
record a screen comprising the video conference for a swearing in of the witness, the swearing in conducted by the notary over the video conference; and
generate an e-notary journal data file for the e-notary, the e-notary journal data file based at least in part on the identity of the witness and the recording of the screen comprising the video conference.

14. The system of claim 12, wherein the computing device configured to verify the identity of a witness is further configured to:
input a primary contact information of the witness;
send a prompt to the primary contact information of the witness to upload, or otherwise transmit, a photograph of an identification of the witness;
receive the photograph of the identification of the witness; and
store the identification of the witness in an encrypted format.

15. The system of claim 12, wherein the computing device configured to verify the identity of a witness is further configured to:
input a primary contact information of an attorney of the witness;
send a prompt to the primary contact information of the attorney to provide an affirmation from the attorney of the identity of the witness; and
receive the affirmation from the attorney of the identity of the witness.

16. The system of claim 15, wherein the computing device is further configured to:
send a prompt to the primary contact information of the attorney to upload, or otherwise transmit, a photograph of an identification of the attorney;
receive the photograph of the identification of the attorney; and
store the identification of the attorney in an encrypted format.

17. The system of claim 12, wherein the computing device configured to merge the first audio track of the witness and the second audio track of the notary to form the system audio track is further configured to:
match an audio tempo of each of the first audio track and the second audio track such that the first audio track and the second audio track are in sync.

18. The system of claim 12, wherein the computing device configured to record the system audio track and the video of the video conference for the swearing in of the witness is further configured to:
prompt the notary to record via a web browser;
prompt the notary to select a screen comprising the video conference;
record the screen comprising the video conference; and
prompt the notary to stop recording via the web browser.

19. The system of claim 12, wherein the computing device is on a user device of the notary.

20. The system of claim 12, wherein the computing device configured to generate the e-notary journal data file for the e-notary is further configured to:
associate an encryption key with the e-notary journal data file; and
store the e-notary journal data file in an encrypted format.

21. The system of claim 20, wherein the computing device is further configured to:
store time and date data associated with the e-notary journal data file; and
provide a token to the notary to access the encrypted format to retrieve the e-notary journal data file.

22. The system of claim 12, wherein the computing device is further configured to:
receive information about the witness,
wherein the information about the witness comprises at least one of a first name, a last name, and a witness type, and
wherein the e-notary journal data file comprises the information about the witness.

23. A non-transitory computer-readable storage medium having computer-executable instructions stored thereon for journalizing an e-notary, wherein executing the computer-executable instructions on a computing device causes the computing device to:
verify the identity of a witness;
merge a first audio track of the witness and a second audio track of a notary to form a system audio track;
record the system audio track and a video of a video conference for a swearing in of the witness, the swearing in conducted by the notary over the video conference; and
generate an e-notary journal data file for the e-notary, the e-notary journal data file based at least in part on the identity of the witness and the recording of the system audio track and the video.

24. A non-transitory computer-readable storage medium having computer-executable instructions stored thereon for journalizing an e-notary, wherein executing the computer-executable instructions on a computing device causes the computing device to:
verify the identity of a witness;
conduct a video conference between the witness and a notary;
record a screen comprising the video conference for a swearing in of the witness, the swearing in conducted by the notary over the video conference; and
generate an e-notary journal data file for the e-notary, the e-notary journal data file based at least in part on the identity of the witness and the recording of the screen comprising the video conference.

25. The non-transitory computer-readable storage medium of claim 23, wherein the computing device caused to verify the identity of a witness is further caused to:
input a primary contact information of the witness;
send a prompt to the primary contact information of the witness to upload, or otherwise transmit, a photograph of an identification of the witness;
receive the photograph of the identification of the witness; and
store the identification of the witness in an encrypted format.

26. The non-transitory computer-readable storage medium of claim 23, wherein the computing device caused to verify the identity of a witness is further caused to:
input a primary contact information of an attorney of the witness;
send a prompt to the primary contact information of the attorney to provide an affirmation from the attorney of the identity of the witness; and
receive the affirmation from the attorney of the identity of the witness.

27. The non-transitory computer-readable storage medium of claim 26, wherein the computing device is further caused to:
send a prompt to the primary contact information of the attorney to upload, or otherwise transmit, a photograph of an identification of the attorney;
receive the photograph of the identification of the attorney; and
store the identification of the attorney in an encrypted format.

28. The non-transitory computer-readable storage medium of claim 23, wherein the computing device caused to merge the first audio track of the witness and the second audio track of the notary to form the system audio track is further caused to:
match an audio tempo of each of the first audio track and the second audio track such that the first audio track and the second audio track are in sync.

29. The non-transitory computer-readable storage medium of claim 23, wherein the computing device caused to record the system audio track and the video of the video conference for the swearing in of the witness is further caused to:
prompt the notary to record via a web browser;
prompt the notary to select a screen comprising the video conference;
record the screen comprising the video conference; and
prompt the notary to stop recording via the web browser.

30. The non-transitory computer-readable storage medium of claim 23, wherein the computing device is on a user device of the notary.

31. The non-transitory computer-readable storage medium of claim 23, wherein the computing device caused to generate the e-notary journal data file for the e-notary is further caused to:
associate an encryption key with the e-notary journal data file; and
store the e-notary journal data file in an encrypted format.

32. The non-transitory computer-readable storage medium of claim 31, wherein the computing device is further caused to:
store time and date data associated with the e-notary journal data file; and
provide a token to the notary to access the encrypted format to retrieve the e-notary journal data file.

33. The non-transitory computer-readable storage medium of claim 23, wherein the computing device is further caused to:
receive information about the witness,
wherein the information about the witness comprises at least one of a first name, a last name, and a witness type, and
wherein the e-notary journal data file comprises the information about the witness.
